(19) United States
(12) Patent Application Publication
(10) Pub. No.: US 2024/0054271 A1
(43) Pub. Date: Feb. 15, 2024

(54) METHOD, APPARATUS AND DEVICE FOR CONSTRUCTING FPGA-BASED PROTOTYPE VERIFICATION PLATFORM AND MEDIUM

(71) Applicant: INSPUR SUZHOU INTELLIGENT TECHNOLOGY CO., LTD., Suzhou, Jiangsu (CN)

(72) Inventor: Yi WANG, Suzhou, Jiangsu (CN)

(73) Assignee: INSPUR SUZHOU INTELLIGENT TECHNOLOGY CO., LTD., Suzhou, Jiangsu (CN)

(21) Appl. No.: 18/259,699

(22) PCT Filed: Oct. 29, 2021
(86) PCT No.: PCT/CN2021/127410

§ 371 Date: Jun. 28, 2023

(30) Foreign Application Priority Data
Jun. 9, 2021 (CN) 202110642566.4

(51) Int. Cl. G06F 30/343; G06F 30/347

(52) U.S. Cl. CPC G06F 30/343; G06F 30/347

(57) ABSTRACT

Provided are a method, apparatus and device for constructing a n FPGA based prototype verification platform, and a medium. The method includes: converting, based on a set constraint condition, codes for constructing an FPGA-based prototype verification platform into a gate-level netlist; setting a requirement defined by preset parameters based on a value range of each parameter when timing closure is met, and when an operation result of the gate-level netlist does not meet the requirement defined by the preset parameters, performing physical optimization on the gate-level netlist according to a set parameter optimization rule, where a physical optimization process may be regarded as the process of optimizing the placement of elements in the gate-level netlist; and performing routing on elements in the gate-level netlist that meets the requirement defined by the preset parameters or the gate-level netlist subjected to the physical optimization to obtain the FPGA-based prototype verification platform.

### CROSS-REFERENCE TO RELATED APPLICATION

The present application claims priority to the Chinese patent application No. 202110642566.4, filed before the China National Intellectual Property Administration (CNIPA) on Jun. 9, 2021 and entitled “METHOD, APPARATUS AND DEVICE FOR CONSTRUCTING FPGA-BASED PROTOTYPE VERIFICATION PLATFORM, AND MEDIUM”, which is incorporated herein by reference in its entirety.

### TECHNICAL FIELD

The present disclosure relates to the technical field of product testing, in particular to a method, apparatus and device for constructing a Field Programmable Gate Array (FPGA)-based prototype verification platform, and a computer-readable storage medium.

### BACKGROUND

Prototype verification is a necessary verification process that checks whether a chip is able to achieve an expected result before tapeout of the chip. Due to the high cost of direct tapeout, a common approach is to perform design porting, synthesis, placement and routing and to perform verification on an FPGA-based prototype verification platform. FPGAs are programmable and therefore may be modified and implemented repeatedly until the desired result is achieved.

Timing closure is a process of adjusting and modifying the design during the design of an integrated circuit so that the designed circuit meets timing requirements. The timing closure is an important criterion to determine whether implementation results are usable.

FPGA-based prototype verification is limited by logic resources of the FPGAs, and the design scale is very large. The conventional technologies tend to focus on the efficiency of constructing the FPGA-based prototype verification platform, while ignoring the accuracy of the FPGA-based prototype verification platform for chip verification, resulting in poor timing closure of the constructed FPGA-based prototype verification platform.

As may be seen, how to improve timing closure of an FPGA-based prototype verification platform is a problem that needs to be addressed by those having ordinary skill in the art.

### SUMMARY

The embodiments of the present disclosure provide a method, apparatus and device for constructing an FPGA-based prototype verification platform, and a computer-readable storage medium, which may improve timing closure of an FPGA-based prototype verification platform.

In order to solve the above technical problem, the embodiments of the present disclosure provide a method for constructing an FPGA-based prototype verification platform. The method includes:
converting, based on a set constraint condition, codes for constructing the FPGA-based prototype verification platform into a gate-level netlist;
determining whether an operation result of the gate-level netlist meets a requirement defined by preset parameters;
performing, when the operation result of the gate-level netlist does not meet the requirement defined by the preset parameters, physical optimization on the gate-level netlist according to a set parameter optimization rule; and
performing routing on elements in the gate-level netlist that meets the requirement defined by the preset parameters or the gate-level netlist subjected to the physical optimization to obtain the FPGA-based prototype verification platform.

In some exemplary embodiments, the parameter optimization rule includes a fanout optimization rule, and correspondingly, performing, when the operation result of the gate-level netlist does not meet the requirement defined by the preset parameters, the physical optimization on the gate-level netlist according to the set parameter optimization rule includes:

calling, when a fanout in the operation result does not meet a set quantity of signal drivers, a logical replication instruction to adjust the fanout of the gate-level netlist.

In some exemplary embodiments, the parameter optimization rule includes a timing optimization rule, and correspondingly, performing, when the operation result of the gate-level netlist does not meet the requirement defined by the preset parameters, the physical optimization on the gate-level netlist according to the set parameter optimization rule includes:

calling, when there is a timing violation in the operation result, a timing adjustment instruction to adjust timing of the gate-level netlist.

In some exemplary embodiments, the timing includes setup time and hold time;
correspondingly, calling, when there is the timing violation in the operation result, the timing adjustment instruction to adjust the timing of the gate-level netlist includes:
calling, when there is a setup time violation, a retime instruction to adjust the setup time of the gate-level netlist; and
calling, when there is a hold time violation, a hold fix instruction to adjust the hold time of the gate-level netlist.

In some exemplary embodiments, the parameter optimization rule includes a congestion optimization rule, and correspondingly, performing, when the operation result of the gate-level netlist does not meet the requirement defined by the preset parameters, the physical optimization on the gate-level netlist according to the set parameter optimization rule includes:

calling, when a congestion level in the operation result is greater than or equal to a preset level value, an alternate replication instruction to adjust the congestion level of the gate-level netlist.

In some exemplary embodiments, after performing the physical optimization on the gate-level netlist according to the set parameter optimization rule, the method further includes:
generating a placement file each time the physical optimization is performed, and calling a report generation instruction to generate a corresponding operation result for the gate-level netlist subjected to the physical optimization;
returning, when parameters in an operation result generated after a latest physical optimization are greater than or equal to parameters in an operation result generated after an immediately previous physical optimization, to a placement phase of the immediately previous physical optimization based on the placement file generated after the immediately previous physical optimization;
determining, when the parameters in the operation result generated after the latest physical optimization are smaller than the parameters in the operation result generated after the immediately previous physical optimization, whether the parameters in the operation result generated after the latest physical optimization meet the requirement defined by the preset parameters;
performing, when the operation result generated after the latest physical optimization includes a target parameter that does not meet the requirement defined by the preset parameters, physical optimization on the gate-level netlist based on a parameter optimization rule corresponding to the target parameter; and
performing, when the parameters in the operation result generated after the latest physical optimization meet the requirement defined by the preset parameters, routing on the elements in the gate-level netlist subjected to the latest physical optimization to obtain the FPGA-based prototype verification platform.

In some exemplary embodiments, after performing the routing on the elements in the gate-level netlist subjected to the physical optimization to obtain the FPGA-based prototype verification platform, the method further includes:
determining whether there is a timing violation in the FPGA-based prototype verification platform; and
calling, when there is a timing violation in the FPGA-based prototype verification platform, a post place strategy to adjust the placement of the FPGA-based prototype verification platform, and performing re-routing based on the adjusted placement.

The embodiments of the present disclosure further provide an apparatus for constructing an FPGA-based prototype verification platform. The apparatus includes a conversion unit, a determining unit, an optimization unit, and a routing unit;
the conversion unit is configured to convert, based on a set constraint condition, codes for constructing the FPGA-based prototype verification platform into a gate-level netlist;
the determining unit is configured to determine whether an operation result of the gate-level netlist meets a requirement defined by preset parameters;
the optimization unit is configured to perform, when the operation result of the gate-level netlist does not meet the requirement defined by the preset parameters, physical optimization on the gate-level netlist according to a set parameter optimization rule; and
the routing unit is configured to perform routing on elements in the gate-level netlist that meets the requirement defined by the preset parameters or the gate-level netlist subjected to the physical optimization to obtain the FPGA-based prototype verification platform.

In some exemplary embodiments, the parameter optimization rule includes a fanout optimization rule, and correspondingly, the optimization unit is configured to call, when a fanout in the operation result does not meet a set quantity of signal drivers, a logical replication instruction to adjust the fanout of the gate-level netlist.

In some exemplary embodiments, the parameter optimization rule includes a timing optimization rule, and correspondingly, the optimization unit is configured to call, when there is a timing violation in the operation result, a timing adjustment instruction to adjust timing of the gate-level netlist.

In some exemplary embodiments, the timing includes setup time and hold time;
correspondingly, the optimization unit includes a setup time optimization subunit and a hold time optimization subunit;
the setup time optimization subunit is configured to call, when there is a setup time violation, a retime instruction to adjust the setup time of the gate-level netlist; and
the hold time optimization subunit is configured to call, when there is a hold time violation, a hold fix instruction to adjust the hold time of the gate-level netlist.

In some exemplary embodiments, the parameter optimization rule includes a congestion optimization rule, and correspondingly, the optimization unit is configured to call when a congestion level in the operation result is greater than or equal to a preset level value, an alternate replication instruction to adjust the congestion level of the gate-level netlist.

In some exemplary embodiments, the apparatus further includes a generating unit, a returning unit, and a result determining unit;
the generating unit is configured to generate a placement file each time the physical optimization is performed, and call a report generation instruction to generate a corresponding operation result for the gate-level netlist subjected to the physical optimization;
the returning unit is configured to return, when parameters in an operation result generated after a latest physical optimization are greater than or equal to parameters in an operation result generated after an immediately previous physical optimization, to a placement phase of the immediately previous physical optimization based on the placement file generated after the immediately previous physical optimization;
the result determining unit is configured to determine, when the parameters in the operation result generated after the latest physical optimization are smaller than the parameters in the operation result generated after the immediately previous physical optimization, whether the parameters in the operation result generated after the latest physical optimization meet the requirement defined by the preset parameters;
the optimization unit is further configured to perform, when the operation result generated after the latest physical optimization includes a target parameter that does not meet the requirement defined by the preset parameters, physical optimization on the gate-level netlist based on a parameter optimization rule corresponding to the target parameter; and
the routing unit is further configured to perform, when the parameters in the operation result generated after the latest physical optimization meet the requirement defined by the preset parameters, routing on the elements in the gate-level netlist subjected to the latest physical optimization to obtain the FPGA-based prototype verification platform.

In some exemplary embodiments, the apparatus further includes a timing determining unit and an adjustment unit;
the timing determining unit is configured to determine, after performing the routing on the elements in the gate-level netlist subjected to the physical optimization to obtain the FPGA-based prototype verification platform, whether there is a timing violation in the FPGA-based prototype verification platform;
the adjustment unit is configured to call, when there is a timing violation in the FPGA-based prototype verification platform, a post place strategy to adjust the placement of the FPGA-based prototype verification platform; and the routing unit is further configured to perform re-routing based on the adjusted placement.

The embodiments of the present disclosure further provide a device for constructing an FPGA-based prototype verification platform. The device includes:
a memory, configured to store a computer program; and
a processor, configured to execute the computer program to implement operations of the method for constructing the FPGA-based prototype verification platform according to any one of the above.

The embodiments of the present disclosure further provide a computer-readable storage medium having a computer program stored thereon. The computer program, when executed by a processor, implements operations of the method for constructing the FPGA-based prototype verification platform according to any one of the above.

According to the above technical solution, codes for constructing an FPGA-based prototype verification platform are converted into a gate-level netlist based on a set constraint condition, wherein a physical structure of each element and a connection relationship among the elements are recorded in the gate-level netlist. In order to improve accuracy of the FPGA-based prototype verification platform, whether an operation result of the gate-level netlist meets a requirement defined by preset parameters may be determined, wherein the requirement defined by the preset parameters may be set based on a value range of each parameter when the timing closure is satisfied. When the operation result of the gate-level netlist does not meet the requirement defined by the preset parameters, physical optimization is performed on the gate-level netlist according to a set parameter optimization rule. Herein, the physical optimization process may be regarded as a process of optimizing placement of the elements in the gate-level netlist. Routing is performed on the elements in the gate-level netlist that meets the requirement defined by the preset parameters or the gate-level netlist subjected to the physical optimization, so as to obtain the FPGA-based prototype verification platform. In this technical solution, by performing physical optimization on the gate-level netlist, rationality of placement of elements in the gate-level netlist may be ensured, such that the FPGA-based prototype verification platform obtained by routing based on the gate-level netlist subjected to the physical optimization may have high accuracy, and timing closure of an FPGA-based prototype verification platform may be improved.

### BRIEF DESCRIPTION OF THE DRAWINGS

In order to more clearly describe the embodiments of the present disclosure, the drawings that are to be referred for the embodiments will be briefly described hereinafter. Apparently, the drawings described hereinafter merely illustrate some embodiments of the present disclosure, and a person having ordinary skill in the art may also derive other drawings based on the drawings described herein without creative effort.

FIG. 1 is a flow diagram of a method for constructing an FPGA-based prototype verification platform according to the embodiments of the present disclosure;

FIG. 2 is a flow diagram of a method for determining an optimal placement according to the embodiments of the present disclosure;

FIG. 3 is a schematic structural diagram of an apparatus for constructing an FPGA-based prototype verification platform according to the embodiments of the present disclosure; and

FIG. 4 is a schematic structural diagram of a device for constructing an FPGA-based prototype verification platform according to the embodiments of the present disclosure.

### DETAILED DESCRIPTION

The technical solutions of the embodiments of the present disclosure will be clearly and completely described below with reference to the drawings of the embodiments of the present disclosure. Apparently, the embodiments described hereinafter are merely a part of the embodiments of the present disclosure, rather than all the embodiments. Based on the embodiments of the present disclosure, all other embodiments obtained by a person having ordinary skill in the art without creative effort fall within the protection scope of the present disclosure.

In order to make a person having ordinary skill in the art better understand the solutions of the present disclosure, the embodiments of the present disclosure are further described in detail below with reference to the accompanying drawings and the detailed implementations.

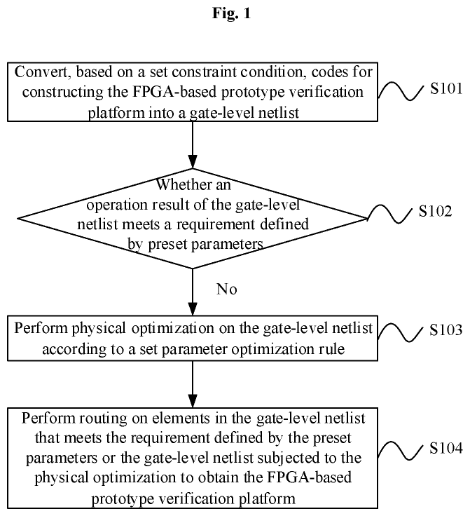

A method for constructing an FPGA-based prototype verification platform according to the embodiments of the present disclosure is described in detail below. FIG. 1 is a flow diagram of the method for constructing the FPGA-based prototype verification platform according to the embodiments of the present disclosure. The method includes the following operations S101 to S104.

At S101, codes for constructing the FPGA-based prototype verification platform are converted into a gate-level netlist based on a set constraint condition.

The constraint condition refers to a restriction condition for constructing the gate-level netlist. The constraint condition may include constraints on a primary clock, automatic constraints on a Phase-Locked Loop (PLL) clock, automatic testing of uncertainty time, paths for which a synthesis tool is not desired for analysis, and constraints on Input/Output (TO) pins.

In practical applications, the codes for constructing the FPGA-based prototype verification platform may be converted into an initial netlist, and design optimization may be performed on the initial netlist based on set design indexes to obtain a logical relationship netlist that meets the design indexes. Elements in the logical relationship netlist are configured into an FPGA based on the constraint condition to obtain the gate-level netlist.

The design indexes may include optimization parameters such as a global buffer (BUFG), a shift register, a memory, and remapping. In the embodiments of the present disclosure, the initial netlist may be optimized into the logical relationship netlist that meets the design indexes according to the requirements for timing, area, power consumption, etc.

At S102, it is determined whether an operation result of the gate-level netlist meets a requirement defined by preset parameters.

The requirement defined by the preset parameters may include requirements for fanout, timing, and congestion. Corresponding value ranges may be set for different types of parameters.

When values of parameters in the operation result of the gate-level netlist do not meet set value ranges, that is, the operation result of the gate-level netlist does not meet the requirement defined by the preset parameters, it is indicated that there is a problem with a current placement manner of the gate-level netlist and physical optimization is required. In this case, S103 may be performed.

At S103, physical optimization is performed on the gate-level netlist according to a set parameter optimization rule.

In conjunction with the above description, the preset parameters may include a fanout, timing and congestion, and correspondingly, the parameter optimization rule may include a fanout optimization rule, a timing optimization rule, and a congestion optimization rule.

Taking the fanout as an example, the fanout indicates the maximum amount of digital signal input that may be driven by a single logic gate. If a fanout value is too high, timing closure of an FPGA-based prototype verification platform may be affected. In practical applications, a high fanout network defined as highfanout_nets is found via a get_nets command, the fanout in an operation result of the high fanout network may be compared with a set quantity of signal drivers, and when the fanout in the operation result does not meet the set quantity of the signal drivers, that is, the fanout is greater than the set quantity of the signal drivers, a logical replication instruction may be called to adjust the fanout of the gate-level netlist.

Taking the timing as an example, the timing may include setup time and hold time. Worst Negative Slack (WNS) represents the timing margin of the worst setup time, and a negative number indicates that the setup time does not meet the timing requirement of the design. Worst Hold Slack (WHS) represents the timing margin of the worst hold time, and a negative number indicates that the hold time does not meet the timing requirement of the design.

In practical applications, whether the WNS and the WHS are positive or negative may be obtained from a timing report. When the WNS or the WHS is negative, it is indicated that there is a timing violation in the operation result, and in this case, a timing adjustment instruction may be called to adjust timing of the gate-level netlist.

For the setup time, if there is a setup time violation, a retime instruction may be called to adjust the setup time of the gate-level netlist. For the hold time, if there is a hold time violation, a hold fix instruction may be called to adjust the hold time of the gate-level netlist.

Taking the congestion as an example, the higher the congestion level, the more likely it is to cause a routing failure. In the embodiments of the present disclosure, the congestion level in the operation result may be compared with a preset level value, and when the congestion level in the operation result is greater than or equal to the preset level value, an alternate replication instruction is called to adjust the congestion level of the gate-level netlist.

The preset level value may be set according to actual requirements, for example, the preset level value may be set to 6.

Congestion is a common cause of the routing failure, so the congestion level may be checked before the routing design. If the congestion level is greater than 6, the design needs to be analyzed to find out the cause of congestion. First, whether a routing latency of a congestion path is too large may be checked. When the routing latency is too large, physical optimization may be performed on the routing latency, and then physical optimization remapping may performed. Physical optimization of the congestion level may be implemented by calling the alternate replication instruction.

When the design scale is very large, the routing time may be very long. When the congestion level is still detected to be greater than 6 after physical optimization is performed, the design may be stopped in time to save time.

At S104, routing is performed on elements in the gate-level netlist that meets the requirement defined by the preset parameters or the gate-level netlist subjected to the physical optimization, so as to obtain the FPGA-based prototype verification platform.

When the gate-level netlist is subjected to the physical optimization or the parameters in the gate-level netlist meet the requirement defined by the preset parameters, it is indicated that the placement of the gate-level netlist is reasonable, and in this case, the routing may be performed according to the elements of the gate-level netlist.

According to the above technical solution, codes for constructing an FPGA-based prototype verification platform are converted into a gate-level netlist based on a set constraint condition, wherein a physical structure of each element and a connection relationship among the elements are recorded in the gate-level netlist. In order to improve accuracy of the FPGA-based prototype verification platform, whether an operation result of the gate-level netlist meets a requirement defined by preset parameters may be determined, wherein the requirement defined by the preset parameters may be set based on a value range of each parameter when the timing closure is satisfied. When the operation result of the gate-level netlist does not meet the requirement defined by the preset parameters, physical optimization is performed on the gate-level netlist according to a set parameter optimization rule. Herein, the physical optimization process may be regarded as a process of optimizing placement of the elements in the gate-level netlist. Routing is performed on the elements in the gate-level netlist that meets the requirement defined by the preset parameters or the gate-level netlist subjected to the physical optimization, so as to obtain the FPGA-based prototype verification platform. In this technical solution, By performing physical optimization on the gate-level netlist, rationality of placement of elements in the gate-level netlist may be ensured, such that the FPGA-based prototype verification platform obtained by routing based on the gate-level netlist subjected to the physical optimization may have high accuracy, and timing closure of an FPGA-based prototype verification platform may be improved.

Considering that when the physical optimization is performed repeatedly between placement and routing, there may be a case where timing for the current optimization is not optimized at all compared to a result of the previous optimization, in order to keep the optimal placement, a current placement may be recorded in the form of a file each time the physical optimization is performed. The optimal placement is determined through continuous physical optimization and comparison of optimization results.

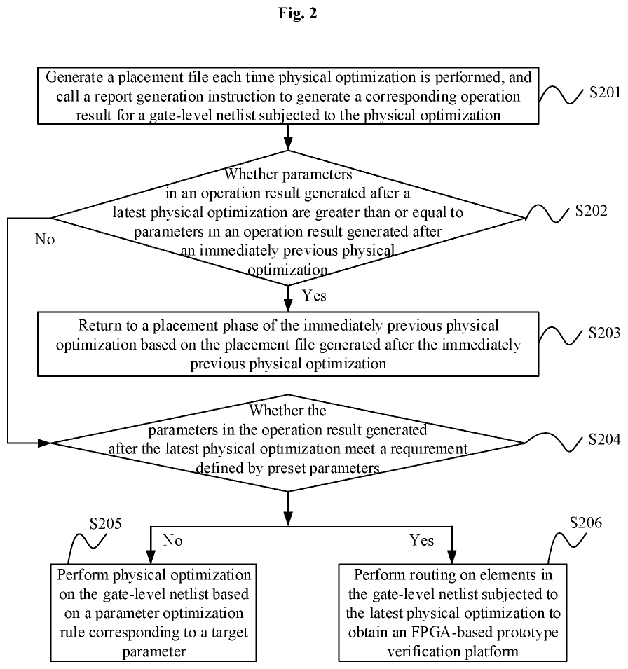

FIG. 2 is a flow diagram of a method for determining the optimal placement according to the embodiments of the present disclosure. The method includes the following operations S201 to S206.

At S201, a placement file is generated each time the physical optimization is performed, and a report generation instruction is called to generate a corresponding operation result for the gate-level netlist subjected to the physical optimization.

The placement file may be a Delphi Compiled Package (.dcp) file. The current placement manner of the gate-level netlist is recorded in the placement file.

At S202, it is determined whether parameters in an operation result generated after a latest physical optimization are greater than or equal to parameters in an operation result generated after an immediately previous physical optimization.

In the embodiments of the present disclosure, when the operation result generated after the current physical optimization (i.e., the latest physical optimization) is not ideal compared to the operation result generated after the immediately previous physical optimization, the operation may go back to the previous .dcp file, that is, S203 is performed.

Compared with the operation result generated after the immediately previous physical optimization, when values of some of the parameters in the operation result generated after the current physical optimization are more in line with the set parameter ranges than the values of the corresponding parameters in the operation result generated after the immediately previous physical optimization, it is indicated that the operation result generated after the current physical optimization is ideal compared to the operation result generated after the immediately previous physical optimization, and in this case, physical optimization may be performed merely on parameters that are still problematic, that is, operations S204 to S206 are performed.

At S203, the process returns to a placement phase of the immediately previous physical optimization based on the placement file generated after the immediately previous physical optimization.

At S204, it is determined whether the parameters in the operation result generated after the latest physical optimization meet a requirement defined by preset parameters.

When the operation result generated after the latest physical optimization includes a target parameter that does not meet the requirement defined by the preset parameters, it is indicated that physical optimization still needs to be performed on the target parameter, and in this case, S205 may be performed.

If the parameters in the operation result generated after the latest physical optimization meet the requirement defined by the preset parameters, it is indicated that the current placement has been optimal, and in this case, S206 may be performed.

At S205, the physical optimization is performed on the gate-level netlist based on the parameter optimization rule corresponding to the target parameter.

The target parameter may be a fanout, timing or congestion, etc. For the optimization of the target parameter, reference may be made to the description of the operation S103, which will not be repeated here. The flow may go back to the operation S202 after the physical optimization is performed on the gate-level netlist.

At S206, routing is performed on the elements in the gate-level netlist subjected to the latest physical optimization to obtain an FPGA-based prototype verification platform.

In the embodiments of the present disclosure, by recording the placement manner each time after the physical optimization is performed and comparing the results of two adjacent physical optimizations, the previous placement manner may be adopted when the current physical optimization is not ideal, such that a relatively optimal placement manner may be obtained after repeated physical optimizations, so that the FPGA-based prototype verification platform obtained after the routing may have high accuracy.

According to the above description, the physical optimizations are performed between placement and routing. Considering that in practical applications, a timing violation may also occur after routing, in the embodiments of the present disclosure, whether there is a timing violation in the FPGA-based prototype verification platform may be determined after the routing is performed on the elements in the gate-level netlist subjected to the physical optimization to obtain the FPGA-based prototype verification platform. If there is a timing violation in the FPGA-based prototype verification platform, a post place (timing constraint) strategy may be called to adjust the placement of the FPGA-based prototype verification platform, and rerouting is performed based on the adjusted placement.

The post place strategy is used to re-place a part with the timing violation, so only the re-placed part needs to be routed, while the other parts with no timing violation still follow an original routing manner.

By checking the timing after routing, the placement and routing of the FPGA-based prototype verification platform may be further optimized, thereby further improving timing closure of an FPGA-based prototype verification platform. Moreover, since only re-placement and re-routing on the part with the timing violation are performed in the optimization after routing, the time required to perform optimization on the FPGA-based prototype verification platform again may be shortened.

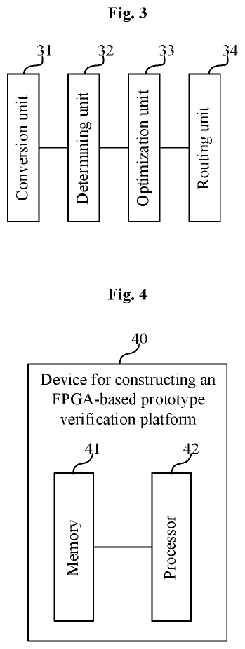

FIG. 3 is a schematic structural diagram of an apparatus for constructing an FPGA-based prototype verification platform according to the embodiments of the present disclosure. The apparatus includes a conversion unit 31, a determining unit 32, an optimization unit 33, and a routing unit 34.

The conversion unit 31 is configured to convert, based on a set constraint condition, codes for constructing the FPGA-based prototype verification platform into a gate-level netlist.

The determining unit 32 is configured to determine whether an operation result of the gate-level netlist meets a requirement defined by preset parameters.

The optimization unit 33 is configured to perform, when the operation result of the gate-level netlist does not meet the requirement defined by the preset parameters, physical optimization on the gate-level netlist according to a set parameter optimization rule.

The routing unit 34 is configured to perform routing on elements in the gate-level netlist that meets the requirement defined by the preset parameters or the gate-level netlist subjected to the physical optimization to obtain the FPGA-based prototype verification platform.

In some exemplary embodiments, the parameter optimization rule includes a fanout optimization rule, and correspondingly, the optimization unit is configured to call, when a fanout in the operation result does not meet a set quantity of signal drivers, a logical replication instruction to adjust the fanout of the gate-level netlist.

In some exemplary embodiments, the parameter optimization rule includes a timing optimization rule, and correspondingly, the optimization unit is configured to call, when there is a timing violation in the operation result, a timing adjustment instruction to adjust timing of the gate-level netlist.

In some exemplary embodiments, the timing includes setup time and hold time.

Correspondingly, the optimization unit includes a setup time optimization subunit and a hold time optimization subunit.

The setup time optimization subunit is configured to call, when there is a setup time violation, a retime instruction to adjust the setup time of the gate-level netlist.

The hold time optimization subunit is configured to call, when there is a hold time violation, a hold fix instruction to adjust the hold time of the gate-level netlist.

In some exemplary embodiments, the parameter optimization rule includes a congestion optimization rule, and correspondingly, the optimization unit is configured to call when a congestion level in the operation result is greater than or equal to a preset level value, an alternate replication instruction to adjust the congestion level of the gate-level netlist.

In some exemplary embodiments, the apparatus further includes a generating unit, a returning unit, and a result determining unit.

The generating unit is configured to generate a placement file each time the physical optimization is performed, and call a report generation instruction to generate a corresponding operation result for the gate-level netlist subjected to the physical optimization.

The returning unit is configured to return, when parameters in an operation result generated after a latest physical optimization are greater than or equal to parameters in an operation result generated after an immediately previous physical optimization, to a placement phase of the immediately previous physical optimization based on the placement file generated after the immediately previous physical optimization.

The result determining unit is configured to determine, when the parameters in the operation result generated after the latest physical optimization are smaller than the parameters in the operation result generated after the immediately previous physical optimization, whether the parameters in the operation result generated after the latest physical optimization meet the requirement defined by the preset parameters.

The optimization unit is further configured to perform, when the operation result generated after the latest physical optimization includes a target parameter that does not meet the requirement defined by the preset parameters, physical optimization on the gate-level netlist based on a parameter optimization rule corresponding to the target parameter.

The routing unit is further configured to perform, when the parameters in the operation result generated after the latest physical optimization meet the requirement defined by the preset parameters, routing on the elements in the gate-level netlist subjected to the latest physical optimization to obtain the FPGA-based prototype verification platform.

In some exemplary embodiments, the apparatus further includes a timing determining unit and an adjustment unit.

The timing determining unit is configured to determine, after performing the routing on the elements in the gate-level netlist subjected to the physical optimization to obtain the FPGA-based prototype verification platform, whether there is a timing violation in the FPGA-based prototype verification platform.

The adjustment unit is configured to call, when there is a timing violation in the FPGA-based prototype verification platform, a post place strategy to adjust the placement of the FPGA-based prototype verification platform.

The routing unit is further configured to perform re-routing based on the adjusted placement.

The description of the features in the embodiment corresponding to FIG. 3 may refer to the relevant descriptions of the embodiments corresponding to FIG. 1 and FIG. 2, which will not be repeated here.

According to the above technical solution, codes for constructing an FPGA-based prototype verification platform are converted into a gate-level netlist based on a set constraint condition, wherein a physical structure of each element and a connection relationship among the elements are recorded in the gate-level netlist. In order to improve accuracy of the FPGA-based prototype verification platform, whether an operation result of the gate-level netlist meets a requirement defined by preset parameters may be determined, wherein the requirement defined by the preset parameters may be set based on a value range of each parameter when the timing closure is satisfied. When the operation result of the gate-level netlist does not meet the requirement defined by the preset parameters, physical optimization is performed on the gate-level netlist according to a set parameter optimization rule. Herein, the physical optimization process may be regarded as a process of optimizing placement of the elements in the gate-level netlist. Routing is performed on the elements in the gate-level netlist that meets the requirement defined by the preset parameters or the gate-level netlist subjected to the physical optimization, so as to obtain the FPGA-based prototype verification platform. In this technical solution, by performing physical optimization on the gate-level netlist, rationality of placement of elements in the gate-level netlist may be ensured, such that the FPGA-based prototype verification platform obtained by routing based on the gate-level netlist subjected to the physical optimization may have high accuracy, and timing closure of an FPGA-based prototype verification platform may be improved.

FIG. 4 is a schematic structural diagram of a device 40 for constructing an FPGA-based prototype verification platform according to the embodiments of the present disclosure. The device includes:
a memory 41, configured to store a computer program; and
a processor 42, configured to execute the computer program to implement operations of the method for constructing the FPGA-based prototype verification platform according to any of the embodiments described above.

The embodiments of the present disclosure further provide a computer-readable storage medium having a computer program stored thereon. The computer program, when executed by a processor, implements operations of the method for constructing the FPGA-based prototype verification platform according to any of the embodiments described above.

The method, apparatus and device for constructing the FPGA-based prototype verification platform, and the computer-readable storage medium according to the embodiments of the present disclosure are described in detail above. The embodiments in the specification are described in a progressive manner, where each embodiment focuses on the differences from the other embodiments, and the same or similar parts between the embodiments may be cross-referenced. For the apparatus provided by the embodiments, since the apparatus corresponds to the method disclosed by the embodiments, the description is relatively simple, and reference may be made to the description of the method section for relevant information. It is to be noted that a person having ordinary skill in the art may also make improvements and modifications to the present disclosure without departing from the principles of the present disclosure, which also fall within the protection scope of the claims of the present disclosure.

It may be further appreciated by a person having ordinary skill in the art that the units and algorithmic operations of examples described in conjunction with the embodiments disclosed herein may be implemented as electronic hardware, computer software, or a combination of both, and that the components and operations of the examples have been described in general terms by function in the above descriptions in order to clearly illustrate the interchangeability of hardware and software. Whether to implement such functionality as hardware or software depends upon the particular application of the technical solutions and constraint conditions of the design. A person having ordinary skill in the art may implement the described functionality in varying ways for each particular application, but such implementation should not be interpreted as causing a departure from the scope of the present disclosure.

The operations of a method or algorithm described in conjunction with the embodiments disclosed herein may be implemented directly as hardware, a software module executed by a processor, or a combination of both. The software module may reside in a Random Access Memory (RAM), an internal memory, a Read-Only Memory (ROM), an electrically programmable ROM, an electrically erasable programmable ROM, a register, a hard disk, a removable disk, a CD-ROM, or any other form of storage medium known in the art.

1. A method for constructing a Field Programmable Gate Array (FPGA)-based prototype verification platform, comprising:
converting, based on a set constraint condition, codes for constructing the FPGA-based prototype verification platform into a gate-level netlist;
determining whether an operation result of the gate-level netlist meets a requirement defined by preset parameters;
performing, when the operation result of the gate-level netlist does not meet the requirement defined by the preset parameters, physical optimization on the gate-level netlist according to a set parameter optimization rule; and
performing routing on elements in the gate-level netlist that meets the requirement defined by the preset parameters or the gate-level netlist subjected to the physical optimization to obtain the FPGA-based prototype verification platform,
wherein after performing the physical optimization on the gate-level netlist according to the set parameter optimization rule, the method further comprises:
generating a placement file each time the physical optimization is performed, and calling a report generation instruction to generate a corresponding operation result for the gate-level netlist subjected to the physical optimization;
returning, when parameters in an operation result generated after a latest physical optimization are greater than or equal to parameters in an operation result generated after an immediately previous physical optimization, to a placement phase of the immediately previous physical optimization based on the placement file generated after the immediately previous physical optimization;
determining, when the parameters in the operation result generated after the latest physical optimization are smaller than the parameters in the operation result generated after the immediately previous physical optimization, whether the parameters in the operation result generated after the latest physical optimization meet the requirement defined by the preset parameters;
performing, when the operation result generated after the latest physical optimization has a target parameter that does not meet the requirement defined by the preset parameters, physical optimization on the gate-level netlist based on a parameter optimization rule corresponding to the target parameter; and
performing, when the parameters in the operation result generated after the latest physical optimization meet the requirement defined by the preset parameters, routing on the elements in the gate-level netlist subjected to the latest physical optimization to obtain the FPGA-based prototype verification platform.

2. The method for constructing the FPGA-based prototype verification platform according to claim 1, wherein the parameter optimization rule comprises a fanout optimization rule, and correspondingly, performing, when the operation result of the gate-level netlist does not meet the requirement defined by the preset parameters, the physical optimization on the gate-level netlist according to the set parameter optimization rule comprises:
calling, when a fanout in the operation result does not meet a set quantity of signal drivers, a logical replication instruction to adjust the fanout of the gate-level netlist.

3. The method for constructing the FPGA-based prototype verification platform according to claim 1, wherein the parameter optimization rule comprises a timing optimization rule, and correspondingly, performing, when the operation result of the gate-level netlist does not meet the requirement defined by the preset parameters, the physical optimization on the gate-level netlist according to the set parameter optimization rule comprises:
calling, when there is a timing violation in the operation result, a timing adjustment instruction to adjust timing of the gate-level netlist.

4. The method for constructing the FPGA-based prototype verification platform according to claim 3, wherein the timing comprises a setup time and a hold time; and
correspondingly, calling, when there is the timing violation in the operation result, the timing adjustment instruction to adjust the timing of the gate-level netlist comprises:
calling, when there is a setup time violation, a retime instruction to adjust the setup time of the gate-level netlist; and
calling, when there is a hold time violation, a hold fix instruction to adjust the hold time of the gate-level netlist.

5. The method for constructing the FPGA-based prototype verification platform according to claim 1, wherein the parameter optimization rule comprises a congestion optimization rule, and correspondingly, performing, when the operation result of the gate-level netlist does not meet the requirement defined by the preset parameters, the physical optimization on the gate-level netlist according to the set parameter optimization rule comprises:
calling, when a congestion level in the operation result is greater than or equal to a preset level value, an alternate replication instruction to adjust the congestion level of the gate-level netlist.

6. The method for constructing the FPGA-based prototype verification platform according to claim 1, wherein after performing the routing on the elements in the gate-level netlist subjected to the physical optimization to obtain the FPGA-based prototype verification platform, the method further comprises:
determining whether there is a timing violation in the FPGA-based prototype verification platform; and
calling, when there is a timing violation in the FPGA-based prototype verification platform, a post place strategy to adjust the placement of the FPGA-based prototype verification platform, and performing re-routing based on the adjusted placement.

7. (canceled)

8. A device for constructing a Field Programmable Gate Array (FPGA)-based prototype verification platform, comprising:
a memory, configured to store a computer program; and
a processor, configured to execute the computer program to implement following operations;
converting, based on a set constraint condition, codes for constructing the FPGA-based prototype verification platform into a gate-level netlist;
determining whether an operation result of the gate-level netlist meets a requirement defined by preset parameters;
performing, when the operation result of the gate-level netlist does not meet the requirement defined by the preset parameters, physical optimization on the gate-level netlist according to a set parameter optimization rule; and
performing routing on elements in the gate-level netlist that meets the requirement defined by the preset parameters or the gate-level netlist subjected to the physical optimization to obtain the FPGA-based prototype verification platform,
wherein the processor is further configured to execute the computer program to implement following operations after performing the physical optimization on the gate-level netlist according to the set parameter optimization rule:
generating a placement file each time the physical optimization is performed, and calling a report generation instruction to generate a corresponding operation result for the gate-level netlist subjected to the physical optimization;
returning, when parameters in an operation result generated after a latest physical optimization are greater than or equal to parameters in an operation result generated after an immediately previous physical optimization, to a placement phase of the immediately previous physical optimization based on the placement file generated after the immediately previous physical optimization;
determining, when the parameters in the operation result generated after the latest physical optimization are smaller than the parameters in the operation result generated after the immediately previous physical optimization, whether the parameters in the operation result generated after the latest physical optimization meet the requirement defined by the preset parameters;
performing, when the operation result generated after the latest physical optimization has a target parameter that does not meet the requirement defined by the preset parameters, physical optimization on the gate-level netlist based on a parameter optimization rule corresponding to the target parameter; and
performing, when the parameters in the operation result generated after the latest physical optimization meet the requirement defined by the preset parameters, routing on the elements in the gate-level netlist subjected to the latest physical optimization to obtain the FPGA-based prototype verification platform.

9. A non-transitory computer-readable storage medium,
having a computer program stored thereon, wherein the computer program, when executed by a processor, causes the processor to implement following operations:
converting, based on a set constraint condition, codes for constructing the FPGA-based prototype verification platform into a gate-level netlist;
determining whether an operation result of the gate-level netlist meets a requirement defined by preset parameters;
performing, when the operation result of the gate-level netlist does not meet the requirement defined by the preset parameters, physical optimization on the gate-level netlist according to a set parameter optimization rule; and
performing routing on elements in the gate-level netlist that meets the requirement defined by the preset parameters or the gate-level netlist subjected to the physical optimization to obtain the FPGA-based prototype verification platform,
wherein the computer program, when executed by the processor, causes the processor to implement following operations after performing the physical optimization on the gate-level netlist according to the set parameter optimization rule:
generating a placement file each time the physical optimization is performed, and calling a report generation instruction to generate a corresponding operation result for the gate-level netlist subjected to the physical optimization;
returning, when parameters in an operation result generated after a latest physical optimization are greater than or equal to parameters in an operation result generated after an immediately previous physical optimization, to a placement phase of the immediately previous physical optimization based on the placement file generated after the immediately previous physical optimization;
determining, when the parameters in the operation result generated after the latest physical optimization are smaller than the parameters in the operation result generated after the immediately previous physical optimization, whether the parameters in the operation result generated after the latest physical optimization meet the requirement defined by the preset parameters;
performing, when the operation result generated after the latest physical optimization has a target parameter that does not meet the requirement defined by the preset parameters, physical optimization on the gate-level netlist based on a parameter optimization rule corresponding to the target parameter; and
performing, when the parameters in the operation result generated after the latest physical optimization meet the requirement defined by the preset parameters, routing on the elements in the gate-level netlist subjected to the latest physical optimization to obtain the FPGA-based prototype verification platform.

10. The method for constructing the FPGA-based prototype verification platform according to claim 1, wherein converting, based on the set constraint condition, the codes for constructing the FPGA-based prototype verification platform into the gate-level netlist comprises:
converting the codes for constructing the FPGA-based prototype verification platform into an initial netlist;
performing design optimization on the initial netlist based on set design indexes to obtain a logical relationship netlist that meets the design indexes; and
configuring elements in the logical relationship netlist into an FPGA based on the constraint condition to obtain the gate-level netlist.

11. The method for constructing the FPGA-based prototype verification platform according to claim 10, wherein the design indexes comprises a global buffer (BUFG), a shift register, a memory, and remapping.

12. The method for constructing the FPGA-based prototype verification platform according to claim 2, wherein the fanout indicates a maximum amount of digital signal input that is able to be driven by a single logic gate.

13. The method for constructing the FPGA-based prototype verification platform according to claim 2, wherein it is determined that the fanout in the operation result does not meet the set quantity of signal drivers when the fanout in the operation result is greater than the set quantity of the signal drivers.

14. The method for constructing the FPGA-based prototype verification platform according to claim 4, wherein the setup time comprises a Worst Negative Slack (WNS); and the hold time comprises a Worst Hold Slack (WHS).

15. The method for constructing the FPGA-based prototype verification platform according to claim 14, wherein it is determined that there is the setup time violation when the WNS is negative; and it is determined that there is the hold time violation when the WHS is negative.

16. The device for constructing the FPGA-based prototype verification platform according to claim 8, wherein the parameter optimization rule comprises a fanout optimization rule, and correspondingly, performing, when the operation result of the gate-level netlist does not meet the requirement defined by the preset parameters, the physical optimization on the gate-level netlist according to the set parameter optimization rule comprises:
calling, when a fanout in the operation result does not meet a set quantity of signal drivers, a logical replication instruction to adjust the fanout of the gate-level netlist.

17. The device for constructing the FPGA-based prototype verification platform according to claim 8, wherein the parameter optimization rule comprises a timing optimization rule, and correspondingly, performing, when the operation result of the gate-level netlist does not meet the requirement defined by the preset parameters, the physical optimization on the gate-level netlist according to the set parameter optimization rule comprises:
calling, when there is a timing violation in the operation result, a timing adjustment instruction to adjust timing of the gate-level netlist.

18. The device for constructing the FPGA-based prototype verification platform according to claim 17, wherein the timing comprises a setup time and a hold time; and
correspondingly, calling, when there is the timing violation in the operation result, the timing adjustment instruction to adjust the timing of the gate-level netlist comprises:
calling, when there is a setup time violation, a retime instruction to adjust the setup time of the gate-level netlist; and
calling, when there is a hold time violation, a hold fix instruction to adjust the hold time of the gate-level netlist.

19. The device for constructing the FPGA-based prototype verification platform according to claim 8, wherein the parameter optimization rule comprises a congestion optimization rule, and correspondingly, performing, when the operation result of the gate-level netlist does not meet the requirement defined by the preset parameters, the physical optimization on the gate-level netlist according to the set parameter optimization rule comprises:
calling, when a congestion level in the operation result is greater than or equal to a preset level value, an alternate replication instruction to adjust the congestion level of the gate-level netlist.

20. The device for constructing the FPGA-based prototype verification platform according to claim 8, wherein the processor is further configured to execute the computer program to implement following operations after performing the routing on the elements in the gate-level netlist subjected to the physical optimization to obtain the FPGA-based prototype verification platform:
determining whether there is a timing violation in the FPGA-based prototype verification platform; and
calling, when there is a timing violation in the FPGA-based prototype verification platform, a post place strategy to adjust the placement of the FPGA-based prototype verification platform, and performing re-routing based on the adjusted placement.

21. The device for constructing the FPGA-based prototype verification platform according to claim 8, wherein converting, based on the set constraint condition, the codes for constructing the FPGA-based prototype verification platform into the gate-level netlist comprises:
converting the codes for constructing the FPGA-based prototype verification platform into an initial netlist;
performing design optimization on the initial netlist based on set design indexes to obtain a logical relationship netlist that meets the design indexes; and
configuring elements in the logical relationship netlist into an FPGA based on the constraint condition to obtain the gate-level netlist.
